(19) United States
(12) Patent Application Publication
(10) Pub. No.: US 2006/0254899 A1
(43) Pub. Date: Nov. 16, 2006

(54) Foil-type switching element

(76) Inventors: Werner Bieck, Wiltingen (DE); Driss Chabach, Noertrange (LU); Thomas Schleeh, Trier (DE)

Correspondence Address: CANTOR COLBURN, LLP, 55 GRIFFIN ROAD SOUTH, BLOOMFIELD, CT, 06002, US

(21) Appl. No.: 10/538,598

(22) PCT Filed: Dec. 8, 2003
(86) PCT No.: PCT/EP03/50961

§ 371 Date: May 1, 2006

(30) Foreign Application Priority Data
Dec. 9, 2002 (EP) 02102704.0

(51) Int. Cl. H01H 1/02

(52) U.S. Cl. 200/511

(57) ABSTRACT

A foil-type switching element includes a first carrier foil and a second carrier foil arranged at a distance from each other by means of a spacer, the spacer including at least one recess defining an active area of the switching element. At least two electrodes are arranged in the active area of the switching element between the first and second carrier foils in such a way that, in response to a pressure acting on the active area of the switching element, the first and second carrier foils are pressed together against the reaction force of the elastic carrier foils and an electrical contact is established between the at least two electrodes. At least one of the first and second carrier foils includes a multi-layered configuration with an inner supporting foil and an outer elastic activation layer, the outer elastic activation layer being deformable in response to pressure acting thereon in such a way that the outer elastic activation layer presents a greater thickness in a central region of the active area than in a peripheral region of the active area, and thereby presses the inner supporting foil towards the other carrier foil in said the central region.

The present invention relates to a foil-type switching element comprising a first carrier foil and a second carrier foil arranged at a certain distance from each other by means of a spacer. The spacer comprises at least one recess, which defines an active area of the switching element. At least two electrodes are arranged in the active area of the switching element between said first and second carrier foils in such a way that, in response to a pressure acting on the active area of the switching element, the first and second carrier foils are pressed together against the reaction force of the elastic carrier foils and an electrical contact is established between the at least two electrodes.

Several embodiments of such foil-type switching elements are well known in the art. Some of these switching elements are configured as simple switches comprising e.g. a first electrode arranged on the first carrier foil and a second electrode arranged on the second carrier foil in a facing relationship with the first planar electrode. The electrodes may be of a planar configuration covering essentially the entire surface of the respective carrier foil inside of the active area.

Other switching elements known in the art are configured as pressure sensors having an electrical resistance, which varies with the amount of pressure applied. In a first embodiment of such pressure sensors, a first electrode is arranged on the first carrier foil and a second electrode is arranged on the second carrier foil in facing relationship with the first electrode. At least one of the electrodes is covered by a layer of pressure sensitive material, e.g. a semi-conducting material, such that when the first and second carrier foils are pressed together in response of a force acting on the switching element, an electrical contact is established between the first and second electrode via the layer of pressure sensitive material. The pressure sensors of this type are frequently called to operate in a so called “through mode”.

In an alternative embodiment of pressure sensors, a first and a second electrode are arranged in spaced relationship on one of the first and second carrier foils while the other carrier foil is covered with a layer of pressure sensitive material. The layer of pressure sensitive material is arranged in facing relationship to the first and second electrode such that, when said first and second carrier foils are pressed together in response to a force acting on the active area of the switching element, the layer of pressure sensitive material shunts the first and second electrode. These sensors are called to operate in the so-called “shunt mode”.

The above-described switching elements can be manufactured cost-effectively and have proven to be extremely robust and reliable in practice.

The electrical response of such a switching element depends on the type of the electrodes, the presence of a possible layer of pressure sensitive material, the design of the electrodes and their arrangement within the active area of the switching element and finally on the physical contact, which is established between the electrodes in response to a force acting on the active area. The physical contact between the electrodes is determined by the mechanical response of the switching element in case of a force acting on the active area. This mechanical response can be described by a membrane model. The deflection of the membrane is proportional to the pressure acting vertically on the membrane and depends on the elastic properties of the membrane, its thickness and the radius of the restraining device.

This mechanical response can be negatively affected if the sensor is arranged underneath a cover material, especially if the cover material is rather rigid and/or strongly taut above the switching element. In this case, a major part of the force acting on the cover material in the region of the active area is deviated by the cover material towards the spacer region of the switching element. It follows that in this case the sensibility of the switching element may be reduced.

### OBJECT OF THE INVENTION

It is an object of the present invention to provide an improved foil-type switching element, which alleviates the above-described drawback.

### GENERAL DESCRIPTION OF THE INVENTION

The above-mentioned problems may be alleviated by a switching element according to the present invention. The proposed switching element comprises first carrier foil and a second carrier foil arranged at a certain distance from each other by means of a spacer, said spacer comprising at least one recess defining an active area of the switching element, and at least two electrodes arranged in the active area of the switching element between said first and second carrier foils in such a way that, in response to a pressure acting on the active area of the switching element, the first and second carrier foils are pressed together against the reaction force of the elastic carrier foils and an electrical contact is established between the at least two electrodes. According to the invention at least one of said first and second carrier foils comprises a multi-layered configuration with an inner supporting foil and an outer elastic activation layer for introducing a force acting on the switching element into a central region of said active area of said switching element.

In the switching element of the present invention, the evolution of the membrane deflection is controlled by a supplemental activation layer. Depending on the elasto-mechanical characteristics of this activation layer, the introduction of the force into the membrane system can be adjusted in a controlled manner. If a force acts on the switching element, the outer activation layer is compressed and, as a reaction to this compression, acts itself on the inner supporting foil. It follows that the membrane deformation occurs under well defined conditions and is accordingly substantially independent of the nature and the characteristics of the material of the sensor surroundings, e.g. different foams or cover materials in a seat. Even if, due to the properties of a cover material, a force acting on the switching element is deviated towards a region, which is offset of the center of the active zone, the reaction force of the compressed activation layer is directed to a central region of the active area. It follows that the activation layer deviates the force acting on the switching element towards the center of the active area, such that a deflection of the membrane occurs even of the outer force is offset of the center of the active area. Accordingly an activation of the switching element is possible under conditions, under which a conventional switching element has no response at all. In fact, due to the force transfer functionality of the activation layer, the present switching element may even be mounted below a stiff actuator.

As a reaction to a force acting on the switching element, the activation layer is compressed and therefore reacts onto the inner supporting foil. In order to press the inner supporting foil onto the opposite carrier foil, the reaction of the compressed activation layer must be sufficient for deflecting the inner supporting foil at least about a distance which corresponds to the distance between the two carrier foils. It follows that the thickness of the activation layer must be higher than the gap between the two carrier foils. It should be noted here, that in order to be able to activate the switching element, the compressibility of the activation layer material may be smaller if the thickness of the activation layer is high. In a preferred embodiment the thickness of said activation layer is therefore substantially larger than the distance between the first and second supporting foil. The thickness of the activation layer may e.g. be 10 times larger than the gap between the two carrier foils. An activation layer with such a thickness enables the use of materials having a comparatively small compressibility. Such materials provide a more linear compression behaviour, resulting in a better control of the switching behaviour of the switching element.

It will be noted, that the activation layer can be chosen from a large variety of suitable materials. The activation layer may e.g. comprise a foam material and/or silicon gel and/or a rubber like material and/or a fluid filled cushion.

In a preferred embodiment of the invention, both said first and said second carrier foils comprise a multi-layered configuration with an inner supporting foil and an outer elastic activation layer for introducing a force acting on the switching element into a central region of said active area of said switching element. In this case, the mechanical response of both carrier foils shows the above described improved behavior. It should be noted, that the second activation layer may have different elasto-mechanical properties that the first activation layer, thus conferring an asymmetric mechanical response to a so configured switching element. It will be appreciated, that such asymmetric mechanical response may also be obtained if both supporting layers have different mechanical properties.

In the case of two activation layers, the combined thickness of the two activation layers is preferably larger than the distance between the first and second supporting foil.

In order to confer the improved mechanical response of the switching element, said outer activation layer may be located only in the region of said active area. This embodiment requires a minimum of activation layer material, which depending on the material and the design of the activation layer can be an important issue for the fabrication costs of the switching element. Especially in case of a switching mat, where a plurality of switching elements are provided with common carrier foils, such an embodiment could lead to a more complicated production process. In an alternative embodiment of the invention, the outer activation layer therefore extends substantially over the entire area of the inner supporting foil.

In a very simple embodiment, the foil-type switching element is configured as a simple membrane switch. In this case a first electrode is arranged on an inner surface of said first carrier foil and a second electrode is arranged on an inner surface of the second carrier foil in a facing relationship with said first electrode. In a variant of a simple switch, a first and a second electrode are arranged side by side on an inner surface of said first carrier foil and a shunt element is arranged on an inner surface of the second carrier foil in facing relationship with said first and second electrodes.

While the advantage of the multi-layered configuration of the carrier foil is well present in those simple switches, it gets even more important in the case of foil-type pressure sensors. Such foil-type pressure sensors are generally configured as the above described switches. In contrast to these switches, at least one of said first and second electrode is covered by a pressure-sensitive resistive material. In an alternative embodiment, the said shunt element comprises a resistive material. Due to the pressure-sensitive resistive or semi-conducting material, the electrical resistance between the electrodes of these pressure sensors depends on the pressure with which the two carrier foils are pressed together. Depending on the type of sensor, the resistance between the connections of the two electrode arrangements depends e.g. on the radius or the size of the contact surface between the two electrode arrangements. As the size of the contact area depends of on the pressure acting on the switching element, the electrical resistance of the switching element is directly correlated to the pressure acting on the switching element.

It will be appreciated that the above described pressure sensors may be of several different types. In a possible embodiment of the sensors, the first electrode comprises a planar electrode covering substantially the entire surface of the active area of said switching element, whereas said second electrode comprises an peripheral electrode arranged substantially at a periphery of said active area, said resistive layer extending inwardly from said peripheral electrode. If a voltage is applied across the electrode arrangements and if the planar electrode is pressed against the resistive layer of the second electrode arrangement, an electrical current flows from the periphery of the electrical contact surface radially through the resistive layer towards the peripheral electrode. In this case, the resistance of the switching element is determined by the resistance of the non-contacted region of the resistive layer, i.e. the part of the resistive layer lying between the periphery of the mechanical contact surface and the peripheral electrode. In a variant of this first type of switching elements with two resistive layers, each of said first and second electrode arrangements may comprise a peripheral electrode arranged substantially at a periphery of said active area, said resistive layers extending inwardly from said peripheral electrode.

In an other embodiment of the switching element, each of said first and second electrodes comprises a planar electrode covering substantially the entire surface of the active area of said switching element and said resistive layer is arranged on top of said first or second planar electrode. If a voltage is applied across the electrode arrangements and if the planar electrode is pressed against the resistive layer of the second electrode arrangement, an electrical current flows from the boundary layer between the first electrode arrangement and the resistive layer vertically through the resistive layer towards the second planar electrode. In the present case, the resistance of the switching element is determined by the resistive material below the mechanical contact surface and the second planar electrode.

In yet another embodiment, the two electrodes are arranged in a spaced relationship on a first carrier foil, whereas the second carrier foil is coated by a resistive material, which forms the shunt element of the switching element.

In a preferred embodiment of the invention, at least one of said first and second carrier foils further comprising an outer actuator layer, said actuator layer being arranged on the side of the activation layer, which faces away from the inner supporting foil. The outer actuation layer may e.g. be rigid in order to distribute a force acting on the switching element evenly over the entire surface of the activation layer. As a result, the activation layer is evenly compressed and the force is optimally guided into the active area of the switching element. As a further advantage, a rigid actuator layer acts as a protection layer for the activation layer.

### DETAILED DESCRIPTION WITH RESPECT TO THE FIGURES

The present invention will be more apparent from the following description of a not limiting embodiment with reference to the attached drawings, wherein

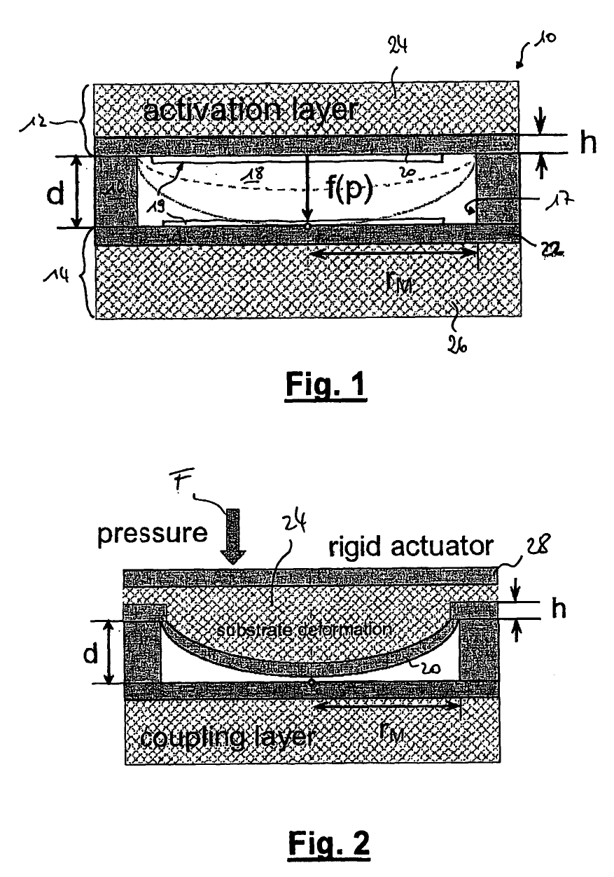

FIG. 1: schematically shows a sectional drawing of a first embodiment of a switching element;

FIG. 2: schematically shows a sectional drawing of a second embodiment of a switching element, the switching element being triggered by a force acting on the switching element;

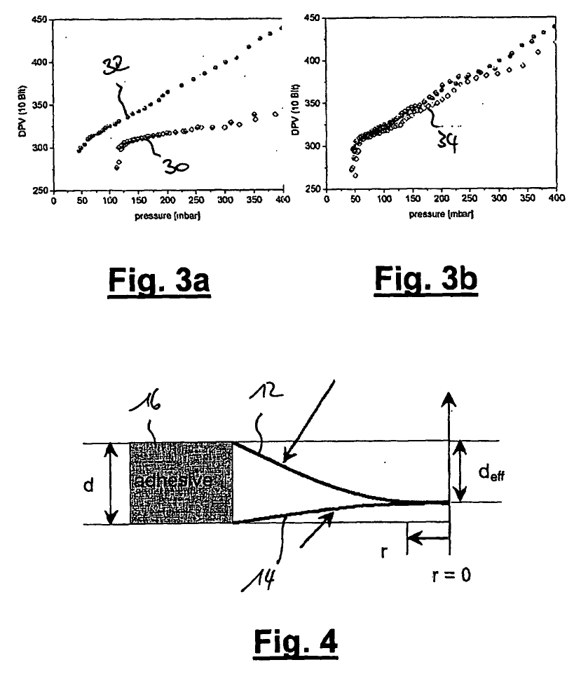

FIG. 3: shows the response functions of a conventional pressure sensor and a pressure sensor according to the present invention;

FIG. 4: shows a sectional drawing of a asymmetric embodiment of a switching element.

FIG. 1 generally represents a sectional drawing of a switching element 10. A first carrier foil 12 and a second carrier foil 14 are arranged at a certain distance d by means of a spacer 16. The spacer 16 comprises a recess or cut-out 17 such that the spacer 16 surrounds an active area 18 of the switching element. Electrodes 19 are arranged on the inner surfaces of the carrier foils in such a way that an electrical contact is established between the electrodes if said carrier foils are pressed together. In the shown embodiment, one electrode 19 is arranged on each of said carrier foils in a facing relationship. It should however be noted that other layouts, e.g. with two spaced electrodes arranged on one of the carrier foils and a shunt element arranged on the second carrier foil, are also possible.

Each of the first and second carrier foil comprises a multi-layered configuration with an inner supporting foil 20 and 22 and an outer activation layer 24 and 26 made of an elastic material. The activation layers 24 and 26, which may be made of an elastic material such as a foam material, a silicon gel, a rubber like material or a fluid filled cushion, are laminated onto the outer surfaces of the supporting foils 20, 22 and are accordingly in contact with the switching element environment. It follows that if a pressure force acts on one of the surfaces of the switching element, the force takes action on the respective activation layer 24, 26. In response to such a pressure acting on the switching element, the elastic activation layer is compressed on its outer surface and, as a reaction to this compression, acts in turn on the underlying supporting foil. This reaction of the activation layer results in the supporting foil being deflected towards the opposite carrier foil until a contact is established between the electrodes 19.

FIG. 2 shows the switching element when subject to a force F acting on the switching element via a rigid actuator 28. Because of the pressure acting on the actuator 28, the activation layer 24 is compressed and reacts on its part on the supporting foil. As can be seen, the compressed activation layer 24 exerts a force on the supporting foil, which causes the supporting foil to be deflected towards the opposite carrier foil. It will be noted that, although the force F is offset from the centre of the active area, the deflection of the supporting foil is symmetrical about the centre of the active area.

In order to provide a reliable reaction on the supporting foil which ensures that the switching element is triggered, the thickness of both the activation layers 24, 26 is chosen so as to be substantially thicker than the thickness of the respective supporting foils 20 and 22. It will however be noted that the two activation layers 24 and 26 of the embodiment shown in FIG. 1 have a different thickness. This difference results in a different mechanical behaviour of the activation layer and accordingly to an asymmetric mechanical response of the switching element. Such an asymmetric behaviour may also be reached by providing the two activation layers 24 and 26 of different elastic material or by using supporting foils 20 and 22 which have distinct mechanical properties.

An asymmetric mechanical response of a switching element is schematically represented in FIG. 4. In the shown embodiment, the lower carrier foil 14 shows a higher rigidity than the upper carrier foil 12, such that the lower carrier foil is less deflected than the upper carrier foil.

FIG. 3a shows at the triggering behaviour of a specific pressure sensor design arranged on a foam material during a planar activation by a mechanically rigid actuator. The graph of this triggering behaviour is generally referenced by 30. The sensor triggers at a pressure of about p=100 mbar and shows only a weak dependency of the acting force. This dependency largely differs from the desired linear nominal behaviour (graph 32).

If however a supplemental activation layer is arranged between the rigid actuator and the sensor, the sensor reacts much more sensitively under the same operating conditions and exhibits a response function (34) which is proportional to the acting force, i.e. the response function is parallel to the desired nominal behaviour. This response function is shown in FIG. 3b.

1.-15. (canceled)

16. Foil-type switching element comprising:
a first carrier foil and a second carrier foil arranged at a distance from each other by means of a spacer, said spacer comprising at least one recess defining an active area of the switching element, and
at least two electrodes arranged in the active area of the switching element between said first and second carrier foils in such a way that, in response to a pressure acting on the active area of the switching element, the first and second carrier foils are pressed together against a reaction force of the elastic carrier foils and an electrical contact is established between the at least two electrodes,
wherein at least one of said first and second carrier foils comprises a multi-layered configuration with an inner supporting foil and an outer elastic activation layer, said outer elastic activation layer being deformable in response to pressure acting thereon in such a way that said outer elastic activation layer presents a greater thickness in a central region of said active area than in a peripheral region of said active area, and thereby presses said inner supporting foil towards the other carrier foil in said central region.

17. Foil-type switching element according to claim 16, wherein a thickness of said activation layer is substantially larger than the distance between the first and second supporting foil.

18. Foil-type switching element according to claim 16, wherein both said first and said second carrier foils comprise a multi-layered configuration with an inner supporting foil and an outer elastic activation layer for introducing a force acting on the switching element into a central region of said active area of said switching element.

19. Foil-type switching element according to claim 18, wherein a combined thickness of the two activation layers is substantially larger than the distance between the first and second supporting foil.

20. Foil-type switching element according to claim 16, wherein said outer activation layer is exclusively located in the region of said active area.

21. Foil-type switching element according to claim 16, wherein said outer activation layer extends substantially over an entire area of the inner supporting foil.

22. Foil-type switching element according to claim 16, wherein a first electrode is arranged on an inner surface of said first carrier foil and a second electrode is arranged on an inner surface of the second carrier foil in a facing relationship with said first electrode.

23. Foil-type switching element according to claim 16, wherein a first and a second electrode are arranged side by side on an inner surface of said first carrier foil and wherein a shunt element is arranged on an inner surface of the second carrier foil in facing relationship with said first and second electrodes.

24. Foil-type switching element according to claim 16, wherein at least one of said first and second electrode is covered by a resistive material.

25. Foil-type switching element according to claim 23, wherein said shunt element comprises a resistive material.

26. Foil-type switching element according to claim 16, wherein at least one of said first and second carrier foils further comprises an outer actuator layer, said actuator layer being arranged on the side of the activation layer, which faces away from the inner supporting foil.

27. Foil-type switching element according to claim 16, wherein said activation layer comprises a foam material.

28. Foil-type switching element according to claim 16, wherein said activation layer comprises a silicon gel.

29. Foil-type switching element according to claim 16, wherein said activation layer comprises a rubber like material.

30. Foil-type switching element according to claim 16, wherein said activation layer comprises a fluid filled cushion.
